(19) United States
(12) Patent Application Publication
(10) Pub. No.: US 2012/0272815 A1
(43) Pub. Date: Nov. 1, 2012

(54) Magnetic Instrument Pickup

(75) Inventors: Thomas Lingel, Fayetteville, NY (US); Graeme Bunce, Chittenango, NY (US); Mark Bowyer, Manlius, NY (US)

(73) Assignee: ANAREN, INC., East Syracuse, NY (US)

(21) Appl. No.: 13/523,294

(22) Filed: Jun. 14, 2012

Related U.S. Application Data
(63) Continuation-in-part of application No. 12/915,987, filed on Oct. 29, 2010.
(60) Provisional application No. 61/497,097, filed on Jun. 15, 2011.
(60) Provisional application No. 61/498,811, filed on Jun. 20, 2011.
(60) Provisional application No. 61/501,023, filed on Jun. 24, 2011.
(60) Provisional application No. 61/507,688, filed on Jul. 14, 2011.

(51) Int. Cl. G10H 3/18

(52) U.S. Cl. 84/726

(57) ABSTRACT

Various improvements and configurations for magnetic musical instrument pickups. Many of the embodiments discussed herein include printed circuit board (pcb) coils, but other embodiments may involve conventional wire wound coils. In some embodiments, the coils (pcb and/or wire wound) are encased in rigid encasement material (see DEFINITIONS section) to reduce microphony and make a quieter pickup. Also, the use of pcb coils allows for many and various new coil shapes and/or configurations because the footprint and stacking of pcb traces are relatively easy to control and/or change. Also disclosed are electromagnetic field interference reduction techniques and integration of multiple coils directly into a single pcb substrate and/or scratchpate. Also disclosed is the use of Hallbach biasing magnet arrays in connection with wire wound and/or pcb coils.

### RELATED APPLICATION

The present application claims priority to the following: (i) U.S. provisional patent application 61/497,097 filed on 15 Jun. 2011; (ii) U.S. provisional patent application 61/498,811 filed on 20 Jun. 2011; (iii) U.S. provisional patent application 61/501,023 filed on 24 Jun. 2011; (iv) U.S. provisional patent application 61/507,688 filed on 14 Jul. 2011; and (v) U.S. patent application Ser. No. 12/915,987 (the “First Generation Application”) filed 29 Oct. 2010; all of the foregoing document(s) are, in their respective entirety(ies), hereby incorporated by reference herein.

### BACKGROUND OF THE INVENTION

1. Field of the Invention

The present invention relates to musical instrument pickups, more particularly to magnetic musical instrument pickups having coil pickups.

2. Description of the Related Art

Magnetic pickups for musically instruments conventionally include a wire coil which is formed by winding a self supporting wire around a support structure. These will be called wire wound pickups herein. The wire wound pickup will also generally include a permanent magnet and a set of pole pieces. The magnet provides the magnetic flux to magnetize a vibrating string. The pole pieces direct the magnetic field so that there will be a relatively strong magnetic field (that is, many magnetic flux lines) in the vibrating string, and especially in the part of the vibrating string in the vicinity of the coil. For example, the magnet may be located under the coil and the pole piece may extend upwards through the aperture in the center of the coil where it terminates just under a vibrating string of the stringed instrument. The vibration of the magnetized string induces current in the coil. This current forms a signal that is then amplified to make the sound of the stringed instrument. There are many types of wire wound magnetic musical instrument pickups, such as U.S. Pat. No. 2,896,491 (“Lover”) and US patent application 2011/0048215 (“215 Lace”). As a further example, US patent application 2007/0017355 (“355 Lace”) discloses a magnetic musical instrument pickup with hum rejecting shields.

Printed circuit board (PCB) coils (see DEFINITIONS section) are known for various applications. For example, the Tyndall National Institute Brochure entitled “PCB Fluxgate Magnetic Field Sensors” (at techtransfer.ucc.ie/industry/documents/FluxgateleafletlIV13_{—}000.pdf as of 16 May 2012) discloses the use of PCB coils in magnetic field sensors for low intensity magnetic fields, like the Earth's magnetic field.

Other published documents which may contain useful background information, and which may be prior art include the following: (i) US patent application 2006/0174755 (“Ito”); (ii) US patent application 2009/0085706 (“Baarman”); (iii) US patent application 2012/00369893 (“Ambrosino”); (iv) US patent application 2005/0060732 (“Kang”); (v) US patent application 2011/0034069 (“Jacob”); (vi) US patent application 2003/0169039 (“Kang”); (vii) US patent application 2005/0024750 (“Kato”); (viii) US patent application 2006/0077785 (“Kuo”); (ix) http://www2.electronicproducts.com/A_component_that_marks_the_end_of_hand_wou nd_coils_in_datacom-article-poyrc07_jan2012-html.aspx, as of Jan. 1, 2012, pages 1-2 (“electronicproducts.com”); (x) TYCO ELECTRONICS CORPORATION, White Paper, Improving Data Communication Products with Planar Magnetics, 2011, http://www.te.com/planarmag, pages 1-6 (“Tyco”); (xi) U.S. Pat. No. 7,601,908 (“Ambrosino”); and/or (xii) US patent application 2004/0044382 (“Ibrahim”).

Description Of the Related Art Section Disclaimer: To the extent that specific publications are discussed above in this Description of the Related Art Section, these discussions should not be taken as an admission that the discussed publications (for example, published patents) are prior art for patent law purposes. For example, some or all of the discussed publications may not be sufficiently early in time, may not reflect subject matter developed early enough in time and/or may not be sufficiently enabling so as to amount to prior art for patent law purposes. To the extent that specific publications are discussed above in this Description of the Related Art Section, they are all hereby incorporated by reference into this document in their respective entirety(ies).

### BRIEF SUMMARY OF THE INVENTION

As described in the First Generation Application, printed circuit board (PCB) style coils can be used in magnetic pickups for musical instruments, such as six string electric guitars. As described in the First Generation Application, these PCB coils may be used to replace (or perhaps supplement) traditional wire wound coils. The present application builds on this previous work in various ways.

One aspect of the present invention is a magnetic instrument pickup having a coil (a PCB coil or a wire wound coil) that is encased in a relatively rigid material, such as PCB material (see DEFINITIONS section). By encasing the coil in a rigid material, it has been found that the relative motion of the windings of the coil relative to each other and/or the instrument body (this is called “microphony”) can be greatly reduced. This generally results in a much quieter electrical signal from the coil generated in response to the vibration of the magnetized string. The reduction in microphony can lead to a flatter response and a more aesthetically pleasing instrument sound.

Other aspects of the present invention involve many and various new coil shapes and/or configurations that become possible because the footprint and stacking of pcb traces are relatively easy to control and/or change. Other aspects of the present invention involve electromagnetic field interference reduction techniques. Another aspect of the present invention involves integration of multiple coils directly into a single pcb substrate and/or scratchpate. Another aspect of the present invention involves the use of Hallbach biasing magnet arrays.

According to an aspect of the present invention, a magnetic musical instrument pickup is provided for use with a musical instrument. The pickup includes: a coil structure (including multiple loops made of a conductor path); and encasement material. The encasement material is a rigid encasement material (see DEFINITIONS section). The coil structure is at least substantially encased in the encasement material so that the loops of the coil are substantially rigidly constrained from relative movement with respect to each other.

According to another aspect of the present invention, a musical instrument includes: a musical instrument frame; a first magnetizable string; a pickup frame hardware set; a coil structure comprising multiple loops made of a conductor path; and multiple permanent magnets. Each permanent magnet defines a north pole, a south pole and a magnet axis running along a north-to-south pole direction. The first magnetizable string is mechanically connected to the musical instrument frame such that it is free to vibrate. The musical instrument frame and the pickup frame hardware set are mechanically connected to each other. The pickup frame hardware set mechanically connects the coil structure and the plurality of permanent magnets to each other. The permanent magnets are arranged in the pattern of a Hallbach array. The magnets are located and oriented so that the Hallbach array arrangement of the permanent magnets increases magnetic flux density in the vicinity of a portion of the first magnetizable string.

According to another aspect of the present invention, a musical instrument includes: a musical instrument frame; a first magnetizable string; a pickup frame hardware set; a first coil structure (including multiple loops made of a conductor path that defines a first coil axis); and a second coil structure (including multiple loops made of a conductor path that defines a second coil axis). The first magnetizable string is mechanically connected to the musical instrument frame such that it is free to vibrate. The musical instrument frame and the pickup frame hardware set are mechanically connected to each other. The first coil structure is a pcb coil with its multiple loops taking the form of traces and vias. The second coil structure is a pcb coil with its multiple loops taking the form of traces and vias. The pickup frame hardware set includes encasement material in the form of pcb material. The first coil structure is at least substantially encased in the encasement material so that the multiple loops of the coil are substantially rigidly constrained from relative movement with respect to each other. The second coil structure is at least substantially encased in the encasement material so that the multiple loops of the coil are substantially rigidly constrained from relative movement with respect to each other. The first and second coil structures are located in a side-by-side arrangement with the first and second coil axes being at least substantially parallel to each other. A winding direction of the first coil structure is opposite to a winding direction of the second coil structure.

According to another aspect of present invention, a magnetic musical instrument pickup includes: a piece of encasement material (which is made of pcb material formed and arranged as a plurality of layers in a laminate structure); a first pcb coil structure (including a conductor path that includes a plurality of loops that define a first pcb coil axis); and a second pcb coil structure (including a conductor path that includes a plurality of loops that define a second pcb coil axis). The pickup is a laminate structure including multiple layers, with each layer including a layer of encasement material, one loop of the first pcb coil structure and one loop of the second pcb coil structure.

According to another aspect of the present invention, a magnetic musical instrument pickup includes: a printed circuit board (made of pcb material; a first pcb coil structure; and a first magnetic member (including a first permanent magnet). The first pcb coil structure is encased in the pcb material. The printed circuit board has defined therein a first recess. The first recess is located at least substantially within the interior volume of the first coil structure. The first magnetic member is located at least partially in the first recess. The printed circuit board is sized and shaped as a scratchpate that can be mounted on a guitar type musical instrument that is designed to incorporate a scratchpate.

According to another aspect of the present invention, a musical instrument includes: a musical instrument frame; a set of magnetizable strings (including a first string and a second string); a first pcb coil structure; a second pcb coil structure; a set of permanent magnet(s) comprising at least one permanent magnet; and a pickup frame hardware set. The strings of the set of magnetizable strings are each mechanically connected to the musical instrument frame such that each string of the set of strings is free to vibrate. The musical instrument frame and the pickup frame hardware set are mechanically connected to each other. The pickup frame hardware set mechanically connects the first and second pcb coil structures and the set of permanent magnet(s) to the musical instrument frame. The first pcb coil structure is located: (i) in close proximity to the first string; but (ii) not located in close proximity to any of the other strings of the set of magnetizable strings. The second pcb coil structure is located: (i) in close proximity to the second string; but (ii) not located in close proximity to any of the other strings of the set of magnetizable strings.

### BRIEF DESCRIPTION OF THE DRAWINGS

The present invention will be more fully understood and appreciated by reading the following Detailed Description in conjunction with the accompanying drawings, in which:

FIG. 1 is a schematic view of a first embodiment of a musical instrument according to the present invention;

FIG. 2 is a perspective view of a first embodiment of a pickup used in the first embodiment musical instrument;

FIG. 3 is an orthographic top view of a second embodiment of pickup according to the present invention;

FIG. 4 is an orthographic front view of the second embodiment pickup;

FIG. 5 is an orthographic top view of a third embodiment of pickup according to the present invention;

FIG. 6 is an orthographic front view of the third embodiment pickup;

FIG. 7 is a schematic of one layer of a pcb coil structure according to an integrated humbucker aspect of the present invention;

FIG. 8 is a schematic of one layer of a pcb coil structure according to an integrated humbucker aspect of the present invention;

FIG. 9 is a transverse cross-section of a portion of a pcb coil structure for use in pickups of the present invention;

FIG. 10 is an orthographic top view of a portion of a pcb coil trace for use in pickups of the present invention;

FIG. 11 is an orthographic top view of a fourth embodiment of a pickup according to the present invention;

FIG. 12 is a perspective, partially cut-away view of the fourth embodiment pickup;

FIG. 13 is a perspective, partially cut away view of a fifth embodiment of a pickup according to the present invention;

FIG. 14 is an orthographic top view of a sixth embodiment of a pickup according to the present invention;

FIG. 15 is an orthographic top view of a seventh embodiment of a pickup according to the present invention;

FIG. 16 is a perspective, partially cut-away view of a portion of an eighth embodiment of a pickup according to the present invention;

FIG. 17 is a schematic view of a ninth embodiment of a pickup according to the present invention;

FIG. 18 is a perspective, partially cut away view of a tenth embodiment of a pickup according to the present invention;

FIG. 19 is a perspective, partially cut-away view of an eleventh embodiment of a pickup according to the present invention;

FIG. 20 is a schematic view of a second embodiment of a musical instrument according to the present invention;

FIG. 21 is a schematic view of a third embodiment of a musical instrument according to the present invention; and

FIG. 22 is an orthographic front cross-sectional (some cross-hatching omitted for clarity of illustration) view of a pcb coil for use in pickups according to the present invention.

### DETAILED DESCRIPTION OF THE INVENTION

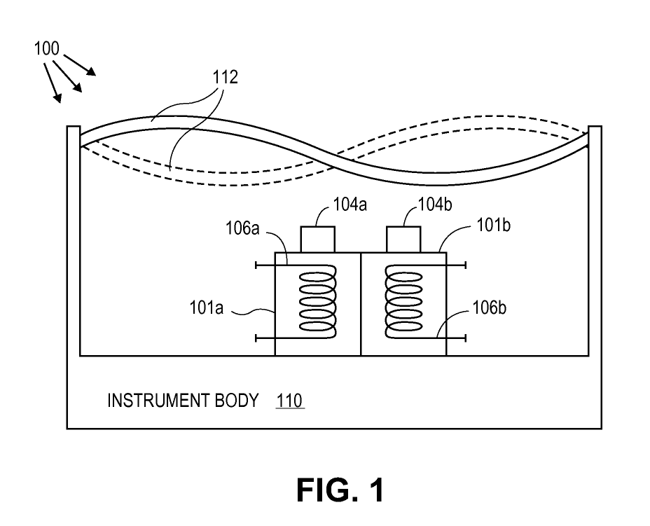

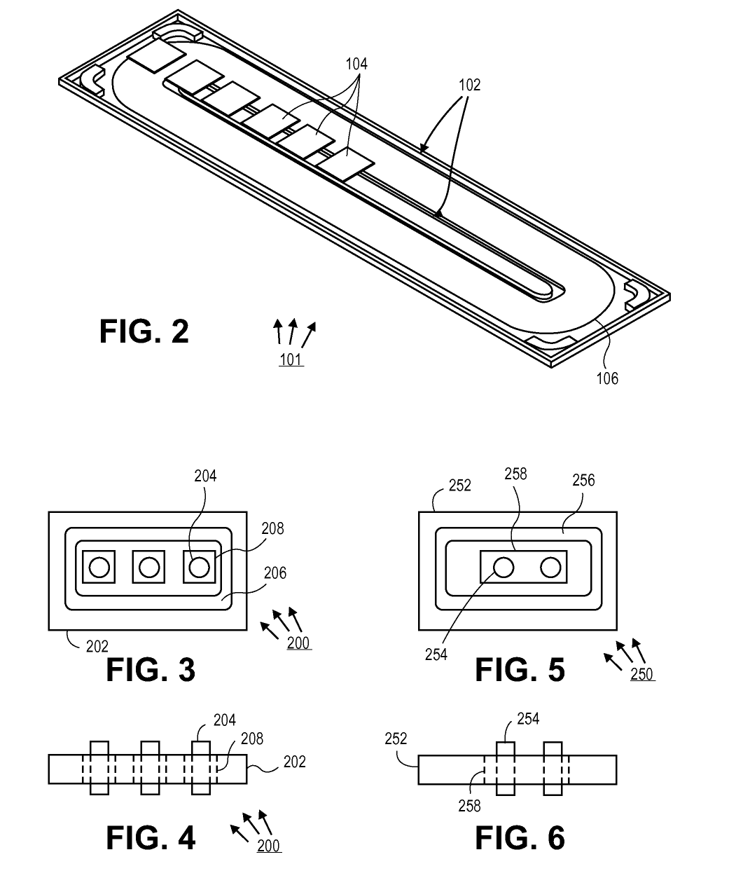

FIGS. 1 and 2 show musical instrument 100 including pickup assemblies 101a, 101b; instrument body 110; and vibrating magnetizable string 112. Each magnetic instrument pickup assembly 101a and 101b respectively includes: substrate material 102; permanent magnets 104; and coil 106. The substrate material is PCB material (see DEFINITIONS section). The coil is a PCB coil (see DEFINITIONS section). Because the coils are encased in a “rigid encasement material” (for example, a polymer based material, such as epoxy resin of the type typically used in laminated pcb manufacture), the pickups are quiet and have a flat response, due to a reduction and/or elimination of microphony in the coil.

In embodiment 100, the magnets are placed on top of the substrate and its embedded coil. Alternatively or additionally, the magnets could be placed on the underside of the substrate/coil board. Magnets on top of the substrate (as shown in FIG. 1) have the advantage of being relatively close to the string, and therefore magnetizing the string to a higher flux density. On the other hand, magnets under the substrate have the advantage of being out of the way, in both the sense that they cannot be seen as easily and the sense that they will not be accidentally touched as easily.

As shown in FIG. 1, the assemblies 101a and 101b are formed as separate piece parts, and then mounted to the instrument body so that the coils 106a and 106b are wound in mutually opposing winding directions. This is sometimes referred to as a humbucker arrangement, and it is believed to be novel to place pcb-coil-based magnetic instrument pickups in a humbucker arrangement. The primary advantage of the humbucker arrangement is that external fields (for example, from fluorescent light fixtures) are effectively cancelled by the fact that the opposing winding direction effectively “cancels out” interference caused by external electromagnetic fields due to the opposing winding direction and that the signals from the coils are combined by other circuitry (not shown) before being output as an electrical audio signal.

As a preferred way of making pickups 101, two separated pcb coils (one clockwise, the other one counterclockwise) are printed simultaneously in a one piece coil stackup and are cut out from the laminated pcb as one piece. The coils are connected at the ends of the winding structure (similar to what one would do using two separately wound solenoids in a conventional wire wound humbucker).

FIGS. 3 and 4 show magnetic musical instrument pickup 200 including: substrate 202; magnetic members 204; and single coil 206 (shown in FIG. 3 only). Substrate 202 has three holes 208 formed therein. These three holes accommodate magnetic members 204. The magnet members may be magnets, pole pieces (that is, material that is magnetizable in any sense) or a combination of the two. As best shown in FIG. 3, there is a clearance gap between the edges of the square hole and the cylindrical magnetic member. Alternatively, the magnetic member could be encased (that is, permanently fixed within) the substrate material. As best shown in FIG. 4, the magnetic members extend both over and under the substrate, but other arrangements are possible. For example the magnetic members could be flush with the major surface of the substrate on one or both sides. As a further alternative, the substrate may extend beyond the magnetic member on one or both major surface sides. As a further alternative, the through holes 208 could be made as recesses for accommodating magnetic members that do not extend all of the way through the substrate.

In embodiment 200, the magnet members are preferably magnetized to define a polar axis that is at least substantially perpendicular to the major surfaces of the substrate encasing the pcb coil. This magnetic field orientation allows for further reduction of the overall height and it also provides a secure way to fix the magnets at a desired location within the pickup.

FIGS. 5 and 6 show pickup 250 including substrate 252; magnetic members 254; and coil 256. In this variation, a single hole 258 in substrate 252 accommodates multiple magnetic members.

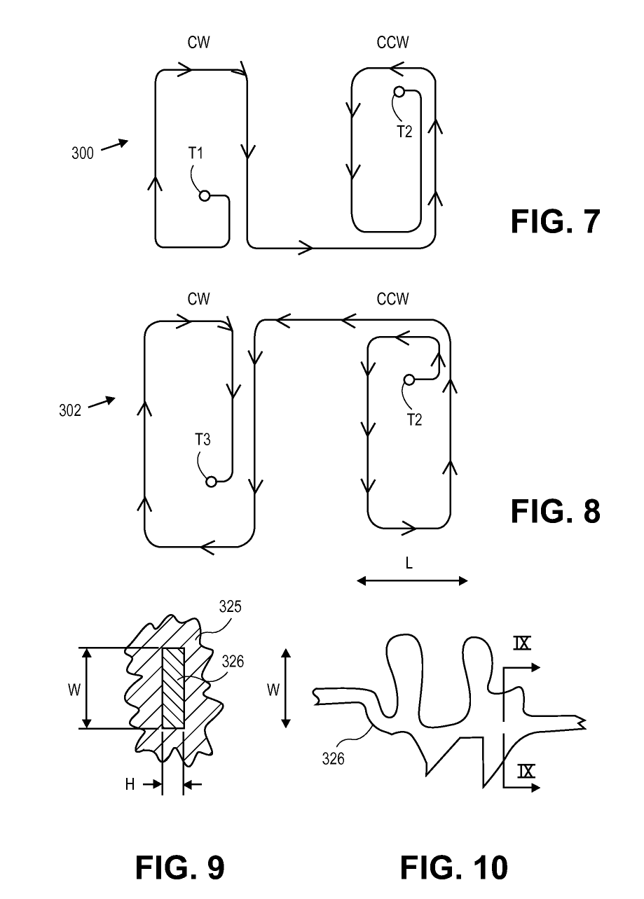

FIGS. 7 and 8 show a schematic for winding an integrated humbucker pcb coil according to the present invention. FIG. 7 shows the trace winding pattern for a first layer 300 of the integrated humbucker coil and FIG. 8 shows the trace winding pattern for the second layer of the integrated humbucker PCB coil. As a preferred way of making integrated humbucker 300, 302, the clockwise and counterclockwise coils are printed and connected on each layer. It is not believed that this integrated winding pattern is used in conventional wire wound coils, and it may not be feasible there.

With pcb coils, on the other hand, this integrated humbucker design is easy and relatively inexpensive to achieve. Also, because both opposing winding direction coils (marked CW and CCW, respectively in FIGS. 7 and 8) are encased within the same substrate, these coils will not only exhibit the reduced microphony and quietness that characterizes pcb-coil-based magnetic instrument pickups in general, but it will also assure the correct positioning of the coils relative to each other, and that the two opposing winding direction coils will not move relative to each other. Of course, fewer piece parts also will tend to reduce inventory and assembly costs, and reduce the possibility of assembly errors in achieving the humbucker arrangement during instrument manufacture or repair. For these reasons, this integrated humbucker design may have advantages even over the pcb-coil-based humbucker arrangement described above in connection with embodiment 100.

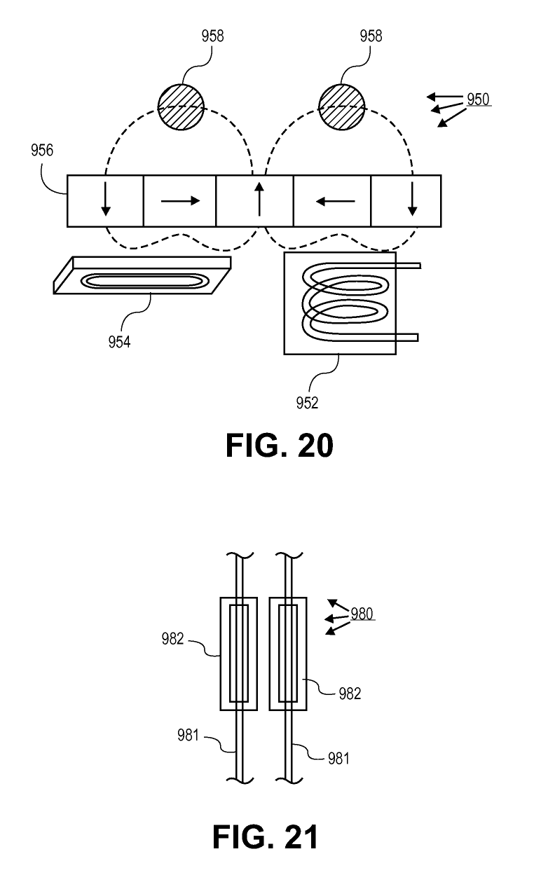

FIG. 20 shows instrument 950 including: wire wound pickup coil 952; pcb pickup coil 945 Hallbach magnet array 956; and vibrating magnetizable strings 958. In embodiments of the invention that include Hallbach array style biasing magnets, magnets 956 are arranged so that field output is low on coil side (where magnetic flux is not particularly helpful), but high on the string side, as shown in FIG. 20. This Hallbach arrangement tends to increase flux density in the vicinity of the magnetizable strings and therefore magnetizes the strings to a greater degree. This, in turn, results in a strong audio electrical signal to be transduced in the pickup coil (traditional wire wound or pcb coil style). One potential advantage of using the pcb coil is that its low profile may leave more space (for example, space between the strings of an electric guitar and the guitar body's upper major surface) for the Hallbach array.

Before moving long to some additional embodiments of magnetic musical instrument pickups according to the present invention, a brief discussion of some pcb coil pickup related terminology will be now presented with reference to FIGS. 9 and 10. FIGS. 9 and 10 show pcb substrate 325 and trace 326. The trace is a pcb-material-supported conductive path parallel to the major surfaces of the substrate in which it is encased and rigidly secured. Because of the way pcb's are manufactured, by lamination of trace-bearing layers formed with appropriate vias, the height H of the trace is quite thin, and also generally fairly uniform (or even constant) over the entire run of the trace. Traces (preferably copper) in a single laminated PCB substrate stack will often all have the same height, and this height is relatively small. Note that the height dimension H shown in FIG. 9 is not drawn to scale. On the other hand, the width W of a trace can vary widely over the length L of the trace. This is shown in FIG. 10 which has been drawn to shown a highly arbitrary trace pattern to demonstrate just how the width and “footprint shape” of the trace can vary along the trace's length.

Furthermore, in a pcb laminated stack assembly according to the present invention, each loop (or set of concentric same-layer loops or portions of a loop or set of same height loops) will occupy its own layer. This means that each loop of the coil may have a very different footprint shape. As one example of this, a pcb coil may be made with wide traces toward the string side of the pcb, but with less wide traces toward the major surface side of the board facing away from the strings. It may also be possible to make a coil that has different quantities of loops at different layers, using conventional pcb traces and pcb vias.

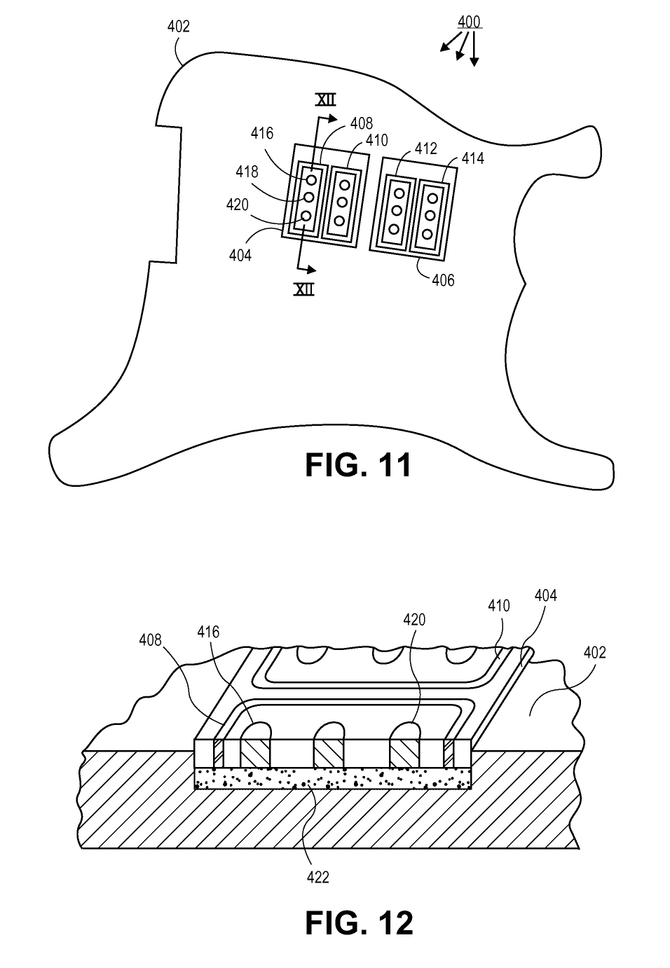

FIGS. 11 and 12 show a magnetic pickup assembly 400 including: scratch plate 402; first substrate 404; second substrate 406; first pcb coil 408; second pcb coil 410; third pcb coil 412; fourth pcb coil 414; pole pieces 416, 418, 420; and permanent magnet 422. As is best seen in FIG. 12, the first and second substrates 404, 406 are partially embedded in the scratch plate member. The magnet magnetizes the pole pieces and, when the scratch plate is mounted in place on an electric guitar body, the pole pieces magnetize the vibrating strings. Preferably each pcb substrate sub-assembly respectively has the integrated double humbucker type winding, discussed above in connection with FIGS. 7 and 8. While this embodiment shows four coils total, the fact that the windings are so low in profile may allow designers to advantageously use even more windings, both in and/or on the scratch plate, and perhaps even on different parts of the electric guitar (such as the neck).

As shown in FIG. 12, the pcb subassembly slightly protrudes from the upper major surface of the scratch plate, but other arrangements are possible. For example, the pcb could be flush with the scratch plate, or, it could be recessed below the upper major surface of the scratch plate. In embodiment 400, the pcb sub-assemblies (including magnet 402) does not extend all of the way through the scratch plate, but this is also possible. By placing the PCB coils in, or partially within, the internal space of the scratch plate both guitar aesthetics and/or audio performance may be improved.

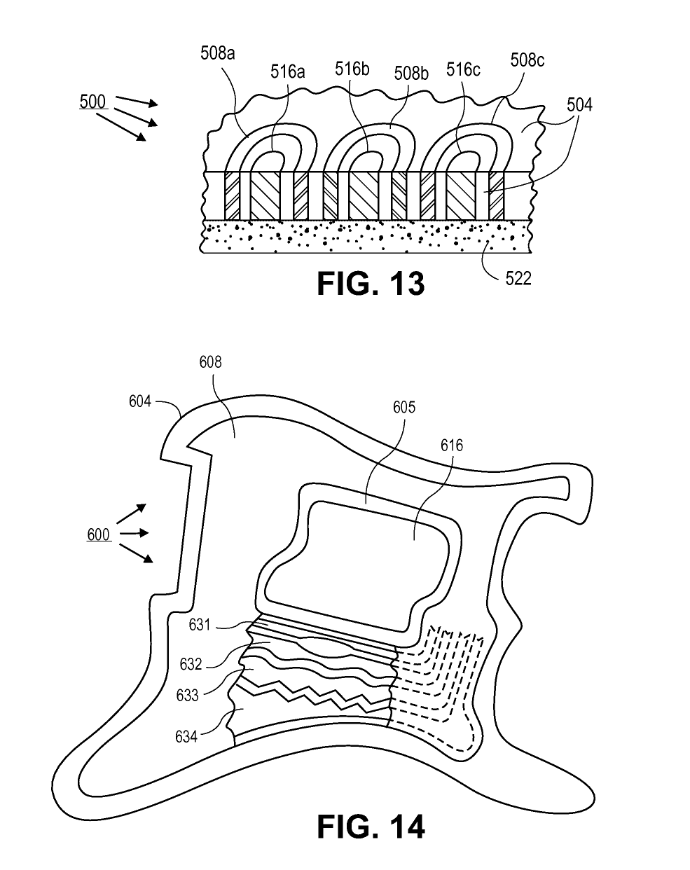

FIG. 13 shows pickup 500, including: magnet 522; three pole pieces 516a,b,c; three pcb coils 508a,b,c and rigid polymer-based substrate 504. In embodiment 600, there is a dedicated winding for each string on the instrument. For example, if the instrument is a six string electric guitar then there would be six windings (a hex coil pickup). This embodiment also has a dedicated pole piece for each winding, and each pole piece is encased in the rigid substrate, along with the coils. Because pcb coils can be made so small, and because they can easily be made with an arbitrary footprint shape, the multiple coil pickup of FIG. 13 is much easier to make than it would be in the context of a conventional wire wound pickup. This is another advantage of pcb coil pickups over conventional wire wound pickups, at least for some applications.

FIG. 14 shows scratch plate pickup 600 including substrate-material scratch plate member 604; and magnetic member 616. Encased within scratch plate member 604 is coil structure 608. Coil structure 608 includes looping traces 631, 632, 633 and 634. Scratch plate member 604 also has through hole (or recess) 605, which is sized and shaped to accommodate the large magnetic member that resides under a relatively large portion of the strings (not shown) of the electric guitar. Coil 608 has a relatively large footprint shape.

Coil 608 also has traces 631, 632, 633, 644 with various footprint shapes that have been selected to be arbitrary to show some of the flexibility in loop conductive path profile that the pcb coils of the present invention allow the guitar pickup designer. It is noted that a pickup coil (pcb or wire wound), with its closely spaced windings, will be characterized by a capacitance and an inductance. This means that the coil acts as a tank circuit and will also be characterized by a resonant frequency. This resonant frequency of the pickup is already well-understood in the art of conventional wire wound pickups. It is known that the location of the resonant frequency, within the audio frequency spectrum, can have an impact on the way the musical instrument sounds. This resonant frequency is often controlled by wire wound pickup designers to tailor and/or optimize the aesthetics of the musical instrument sound, the quality of the sound. However, the use of wire windings generally imposes constraints upon how much the resonant frequency can be “tweaked” in a given wire wound pickup design. On the other hand, the use of pcb coils according to the present invention allows the designer much greater flexibility in controlling the resonant frequency. For example, it generally becomes easier to raise the resonant frequency up out of the human hearing range, which may be a desired effect in a given application. Even is the resonant frequency is desired to be somewhere down in the human hearing range (as it is in the overwhelming majority of conventional wire wound pickups) this adjustment of the resonant frequency becomes easier to tweak and also easier to reliably mass manufacture with accuracy and precision with respect to the characteristic resonant frequency of the pickup.

The design flexibility of pcb coils may also help in the manufacture of coils that act as sustainers and the like. When using the coil as a sustainer, it may be necessary to provide an AC signal to the coil, as is understood in the art of conventional wire wound coil pickups having a sustainer feature.

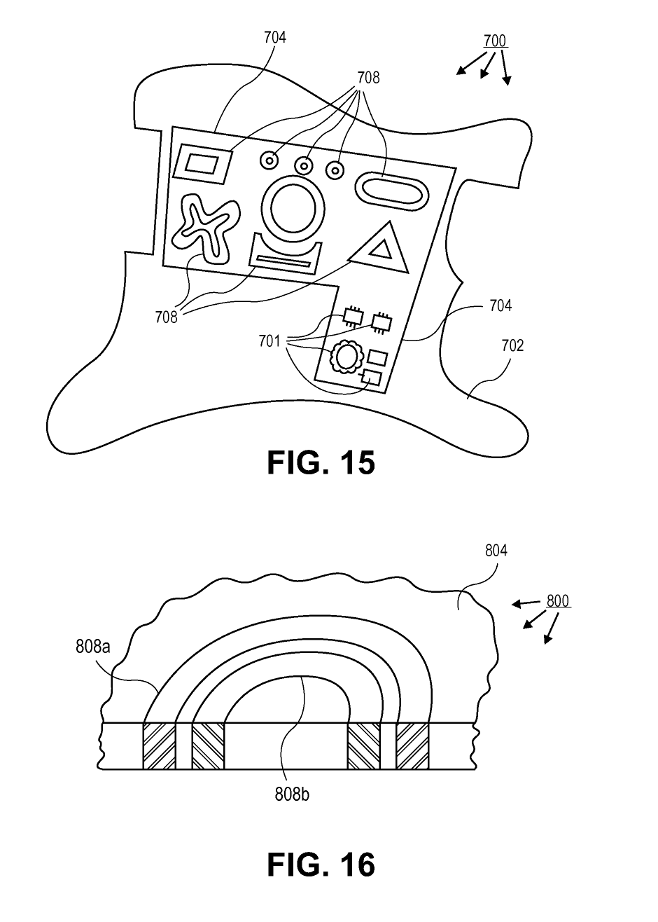

FIG. 15 shows scratch plate assembly 700 including: scratch plate member 702; substrate material 704; pcb mounted electrical components 701; and pcb coils 708. One thing shown by embodiment 700 is that electrical components can be mounted on (and/or in) the same printed circuit board as the one in which the coil(s) are encased and secured. These components may include amplifiers to amplify the electrical audio signals received from the coil(s), preferably through trace(s) and via(s) (not shown) built right into the pcb itself. The board mounted components may be placed on the outward facing (or upwards) side of the pcb and/or on the underside. Another feature of embodiment 700 is the arbitrary nature of the coil footprint shapes. This is shown to emphasize and illustrate the point that the use of pcb coils really opens up possibilities to get new sounds out of electric guitars and other musical instruments with vibrating strings.

FIG. 16 shows pickup 800 including substrate material 804, inner coil 808b and outer coil 808a. In this embodiment, the two coils may be mutually electrically isolated from each other, or not. They may be would in the same winding direction, or in opposite winding directions. In some variations, this novel two coil structure may help cancel electrical interference from external electromagnetic fields. The musical instrument may be structured to allow the instrument player to select which of the two coil(s) are used at any given time to help produce the aggregated electrical audio signal.

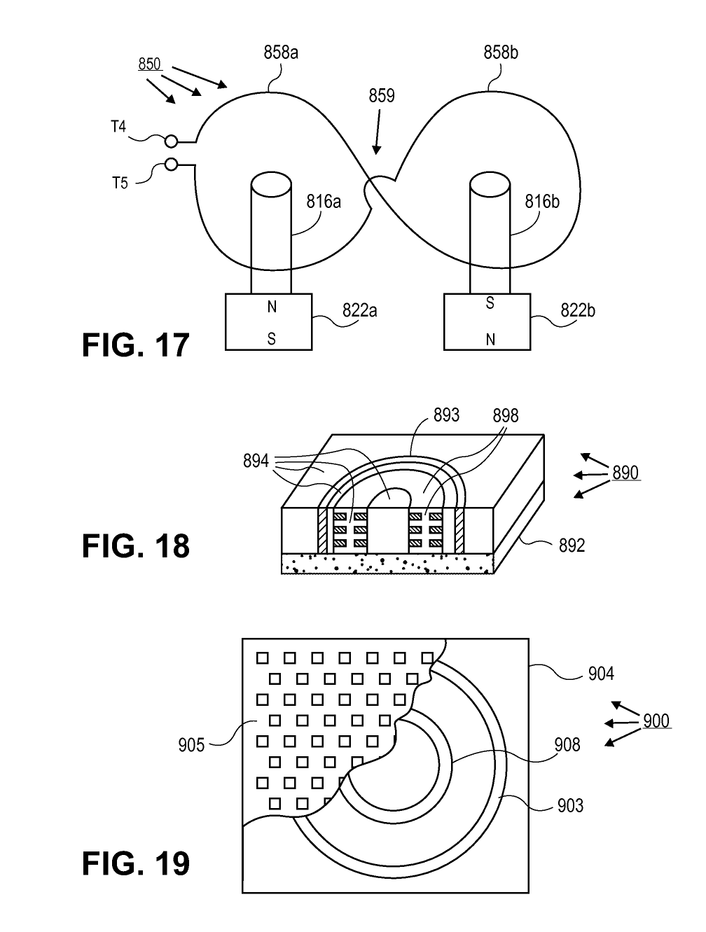

FIG. 17 shows pickup 850 including pole pieces 816a,b; permanent magnets 822a,b; and pcb coil loops 858a,b. In embodiment 850, the two “lobes” are in a figure eight configuration, including crossing point 859. The scheme may be extended to include additional lobes and additional crossing points (which would herein still be referred to as a “figure eight configuration” even in cases where there are additional lobes and crossing points). This configuration is believed to be difficult and/or impossible in the context of conventional wire wound pickups, but is believed to be achievable with the pcb coils of the present invention. It is not yet known what impact this coil configuration might have on the audio performance of a musical instrument.

FIG. 18 shows pickup 890, including: magnet 892; substrate material 894; embedded shield member 893; and pcb coil 898. The shield member is used to reduce magnetic and/or electromagnetic interference from affecting the signal transduced in the pcb coil.

FIG. 19 shows pickup 900, including first shield member 903; substrate material 904; second shield member 905; and pcb coil 908. The first shield member may be similar to the shield member of embodiment 890, discussed above. The second shield member is a mesh laminated onto the top surface of the pcb. Other types of shielding (now known or to be developed in the future), not necessarily involving a mesh structure shield, may also be helpful. This shield is designed to reduce electromagnetic interference in the manner of a Faraday cage. It is noted that any shielding between the pcb coil and the vibrating string should preferably not be a magnetic field shield because this would, of course, prevent the vibration of the string from being transduced into the electric audio signal in the coil.

FIG. 21 shows instrument 980, including: strings 981; and two pcb coils 982. As shown by embodiment 980, in arrangements with a dedicated pcb coil for each string, the coils may be elongated along the string length so that vibration from a relatively long portion of each string will be transduced into the audio electrical signal.

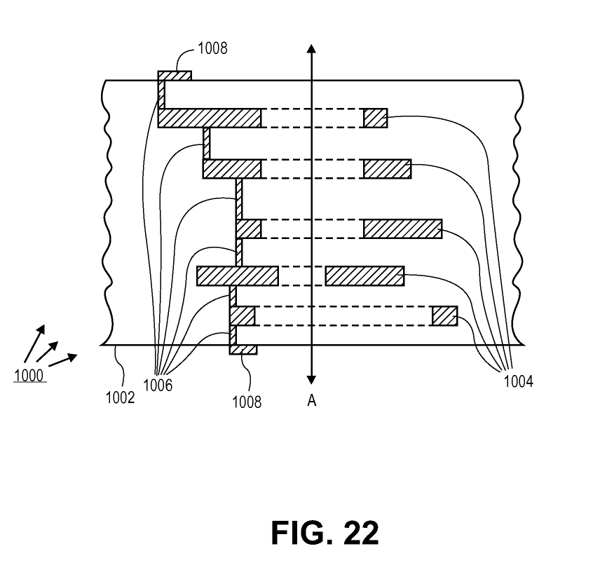

FIG. 22 shows pcb pickup coil 1000, including: laminate pcb encasement material 1002 (layers not separately demarcated for clarity of illustration purposes); loop traces 1004, vias 1006; and pads 1008. As shown in FIG. 22, the footprint of each loop is different in this embodiment.

PCB coil pickups of the present invention may be easily mounted over existing pickup openings in solid body guitars, or over existing sound openings in acoustic guitars. In this way, the pcb coils of the present invention may be used in novel types of retrofittings. As mentioned above, a user switch or dial or other interface device may be used to select which pcb coil(s) are active at any given time in a musical instrument having multiple pcb coils.

In another variation, thin laminated boards (˜1 mil thickness) are used so that more windings can be brought closer to the strings. This will increase the output signal or allows one to get the same signal level with a lower number of windings compared to standard wire wound pickups (wire wound pickups typically use 42 gauge wire which is about 2.8 mil thick).

### Definitions

Any and all published documents mentioned herein shall be considered to be incorporated by reference, in their respective entireties. The following definitions are provided for claim construction purposes:

Present invention: means “at least some embodiments of the present invention,” and the use of the term “present invention” in connection with some feature described herein shall not mean that all claimed embodiments (see DEFINITIONS section) include the referenced feature(s).

Embodiment: a machine, manufacture, system, method, process and/or composition that may (not must) be within the scope of a present or future patent claim of this patent document; often, an “embodiment” will be within the scope of at least some of the originally filed claims and will also end up being within the scope of at least some of the claims as issued (after the claims have been developed through the process of patent prosecution), but this is not necessarily always the case; for example, an “embodiment” might be covered by neither the originally filed claims, nor the claims as issued, despite the description of the “embodiment” as an “embodiment.”

First, second, third, etc. (“ordinals”): Unless otherwise noted, ordinals only serve to distinguish or identify (e.g., various members of a group); the mere use of ordinals shall not be taken to necessarily imply order (for example, time order, space order).

Electrically Connected: means either directly electrically connected, or indirectly electrically connected, such that intervening elements are present; in an indirect electrical connection, the intervening elements may include inductors and/or transformers.

Mechanically connected: Includes both direct mechanical connections, and indirect mechanical connections made through intermediate components; includes rigid mechanical connections as well as mechanical connection that allows for relative motion between the mechanically connected components; includes, but is not limited, to welded connections, solder connections, connections by fasteners (for example, nails, bolts, screws, nuts, hook-and-loop fasteners, knots, rivets, quick-release connections, latches and/or magnetic connections), force fit connections, friction fit connections, connections secured by engagement caused by gravitational forces, pivoting or rotatable connections, and/or slidable mechanical connections.

rigid encasement material: any substantially non-electrically conductive material that is sufficiently rigid so that when it encases a magnetic musical instrument pickup, then relative movement of the loops of the coil of the pickup will be substantially reduced or eliminated; rigid encasement materials may include: ceramic-based material, and polymer-based material (see DEFINITIONS section).

polymer-based material: any relatively rigid (when used to encase coils) material that is made up substantially of polymer material; polymer-based materials include at least some epoxy resins and at least some plastics; “polymer-based materials” would not include wax due to its relative lack of rigidity even when used in encasements for coils.

pcb material: any rigid, electrically insulative polymer-based material (see DEFINITION) that is suitable for making printed circuit boards by lamination operations; one example of pcb material is laminated and hardened epoxy resin of the type used to make currently conventional rigid printed circuit boards.

pcb coil: a coil made of current path member(s) that are not self supporting and must be laminated into a pcb in order to maintain their shape and/or structural integrity.

What is claimed is:

1. A magnetic musical instrument pickup, for use with a musical instrument having at least one magnetizable string, the pickup comprising:
a coil structure comprising a plurality of loops made of a conductor path; and
encasement material;
wherein:
the encasement material is a rigid encasement material; and
the coil structure is at least substantially encased in the encasement material so that the plurality of loops of the coil are substantially rigidly constrained from relative movement with respect to each other.

2. The pickup of claim 1 wherein the coil structure is a polymer-based material.

3. The pickup of claim 1 wherein:
the coil structure is a pcb coil with its plurality of loops taking the form of traces and vias; and
the encasement material is pcb material in a shape that defines a first major surface and a second major surface.

4. The pickup of claim 3 further comprising a first magnetic member, wherein:
the pcb coil defines a coil interior space;
the pcb material includes a recess that extends into the coil interior space; and
a magnetic member located at least substantially within the recess.

5. The pickup of claim 4 wherein the recess is a through hole that extends from the first major surface to the second major surface.

6. The pickup of claim 4 wherein the magnetic member is a permanent magnet.

7. The pickup of claim 4 wherein the magnetic member is a pole piece.

8. The pickup of claim 3 further comprising a magnetic member, wherein the magnetic member is fixed to the first major surface and located at least partially within a footprint of the pcb coil.

9. The pickup of claim 8 wherein the magnetic member is selected from the following types: a magnetic member and a pole piece.

10. The pickup of claim 3 wherein:
the pickup is characterized by a resonant frequency; and
the resonant frequency is above the range of frequencies that can be heard by humans.

11. The pickup of claim 3 wherein:
the pcb coil and the pcb material are in the form of a laminate structure comprising a plurality of layers;
the pcb coil includes a first loop on a first layer of the laminate structure;
the pcb coil includes a second loop on a second layer of the laminate structure; and
the first and second loops have substantially different footprints.

12. A musical instrument comprising:
a musical instrument frame;
a first magnetizable string;
a pickup frame hardware set;
a coil structure comprising a plurality of loops made of a conductor path; and
a plurality of permanent magnets, with each permanent magnet of the plurality of permanent magnets defining a north pole, a south pole and a magnet axis running along a north-to-south pole direction;
wherein:
the first magnetizable string is mechanically connected to the musical instrument frame such that it is free to vibrate;
the musical instrument frame and the pickup frame hardware set are mechanically connected to each other;
the pickup frame hardware set mechanically connects the coil structure and the plurality of permanent magnets to each other;
the plurality of permanent magnets are arranged in the pattern of a Hallbach array; and
the plurality of magnets are located and oriented so that the Hallbach array arrangement of the permanent magnets increases magnetic flux density in the vicinity of a portion of the first magnetizable string.

13. The musical instrument of claim 12 wherein:
the plurality of permanent magnets comprises a first magnet, a second magnet, a third magnet and a fourth magnets;
the first, second, third and fourth magnet are stacked in order; and
the first, second, third and fourth magnets are mutually oriented to that the magnet axes of the first and third magnets are at least substantially perpendicular to the magnet axes of the second and fourth magnets.

14. The musical instrument of claim 12 wherein:
the pickup frame hardware set comprises encasement material; and
the encasement material is a polymer-based material; and
the coil structure is at least substantially encased in the encasement material so that the plurality of loops of the coil are substantially rigidly constrained from relative movement with respect to each other.

15. The musical instrument of claim 14 wherein:
the coil structure is a pcb coil with its plurality of loops taking the form of traces and vias; and
the encasement material is pcb material in a shape that defines a first major surface and a second major surface.

16. A musical instrument comprising:
a musical instrument frame;
a first magnetizable string;
a pickup frame hardware set;
a first coil structure comprising a plurality of loops made of a conductor path that defines a first coil axis; and
a second coil structure comprising a plurality of loops made of a conductor path that defines a second coil axis;
wherein:
the first magnetizable string is mechanically connected to the musical instrument frame such that it is free to vibrate;
the musical instrument frame and the pickup frame hardware set are mechanically connected to each other;
the first coil structure is a pcb coil with its plurality of loops taking the form of traces and vias;
the second coil structure is a pcb coil with its plurality of loops taking the form of traces and vias;
the pickup frame hardware set comprises encasement material in the form of pcb material;
the first coil structure is at least substantially encased in the encasement material so that the plurality of loops of the coil are substantially rigidly constrained from relative movement with respect to each other;
the second coil structure is at least substantially encased in the encasement material so that the plurality of loops of the coil are substantially rigidly constrained from relative movement with respect to each other;
the first and second coil structures are located in a side-by-side arrangement with the first and second coil axes being at least substantially parallel to each other; and
a winding direction of the first coil structure is opposite to a winding direction of the second coil structure.

17. The instrument of claim 16 wherein the first and second coil structures have substantially the same geometry except for that the first and second coil structures have opposite winding directions.

18. The instrument of claim 17 wherein:
the pickup frame hardware set comprises a first piece part and a second piece part which are separate from each other until assembled into place on the instrument;
the first piece part includes the first coil structure encased in pcb material; and
the second piece part includes the second coil structure encased in pcb material.

19. The instrument of claim 17 wherein the pickup frame hardware set comprises a single piece of encasement material which encases both the first and second coil structures.

20. A magnetic musical instrument pickup comprising:
a piece of encasement material which is made of pcb material formed and arranged as a plurality of layers in a laminate structure;
a first pcb coil structure comprising a conductor path that comprises a plurality of loops that define a first pcb coil axis; and
a second pcb coil structure comprising a conductor path that comprises a plurality of loops that define a second pcb coil axis;
wherein:
the pickup is a laminate structure comprising a plurality of layers, with each layer comprising a layer of encasement material, one loop of the first pcb coil structure and one loop of the second pcb coil structure.

21. The pickup of claim 20 wherein:
the first and second pcb coil structures are located in a side-by-side arrangement with the first and second pcb coil axes being at least substantially a parallel to each other; and
a winding direction of the first pcb coil structure is opposite to a winding direction of the second pcb coil structure.

22. The pickup of claim 21 wherein each layer of the laminate structure of the pickup further comprises:
a conductor path electrically connecting the loop of the first pcb coil structure on that layer to the loop of the second pcb coil structure on that layer; and
a via structured, located and/or connected to electrically connect the pcb coil structure loops of that layer of the laminate structure of the pickup to the pcb coil loops of an adjacent layer of the laminate structure of the pickup.

23. A magnetic musical instrument pickup comprising:
a printed circuit board made of pcb material;
a first pcb coil structure; and
a first magnetic member comprising a first permanent magnet;
wherein:
the first pcb coil structure is encased in the pcb material;
the printed circuit board has defined therein a first recess;
the first recess is located at least substantially within the interior volume of the first coil structure;
the first magnetic member is located at least partially in the first recess;
and
the printed circuit board is sized and shaped as a scratchpate that can be mounted on a guitar type musical instrument that is designed to incorporate a scratchpate.

24. The pickup of claim 23 further comprising a first electrical component mounted on and/or in the pcb material of the printed circuit board.

25. The pickup of claim 24 wherein the first electrical component is a power supply circuit used to allow the pickup to perform as an active pickup.

26. The pickup of claim 23 wherein the first magnetic member further comprises a first pole piece.

27. The pickup of claim 23 wherein:
the first recess is a through hole extending between a first major surface and a second major surface of the printed circuit board; and
the first magnetic member extends at least substantially entirely through the first recess.

28. A musical instrument comprising:
a musical instrument frame;
a set of magnetizable strings comprising a first string and a second string;
a first pcb coil structure;
a second pcb coil structure;
a set of permanent magnet(s) comprising at least one permanent magnet; and
a pickup frame hardware set;
wherein:
the strings of the set of magnetizable strings are each mechanically connected to the musical instrument frame such that each string of the set of strings is free to vibrate;
the musical instrument frame and the pickup frame hardware set are mechanically connected to each other;
the pickup frame hardware set mechanically connects the first and second pcb coil structures and the set of permanent magnet(s) to the musical instrument frame;
the first pcb coil structure is located: (i) in close proximity to the first string; but (ii) not located in close proximity to any of the other strings of the set of magnetizable strings; and
the second pcb coil structure is located: (i) in close proximity to the second string; but (ii) not located in close proximity to any of the other strings of the set of magnetizable strings.

29. The instrument of claim 28 further comprising:
a third pcb coil structure;
a fourth pcb coil structure;
a fifth pcb coil structure; and
a sixth pcb coil structure;
wherein:
the musical instrument is an electric guitar;
the set of magnetizable strings further comprises a third string, a fourth string, a fifth string and a sixth string;
the third pcb coil structure is located: (i) in close proximity to the third string; but (ii) not located in close proximity to any of the other strings of the set of magnetizable strings;
the fourth pcb coil structure is located: (i) in close proximity to the fourth string; but (ii) not located in close proximity to any of the other strings of the set of magnetizable strings;
the fifth pcb coil structure is located: (i) in close proximity to the fifth string; but (ii) not located in close proximity to any of the other strings of the set of magnetizable strings; and
the sixth pcb coil structure is located: (i) in close proximity to the sixth string; but (ii) not located in close proximity to any of the other strings of the set of magnetizable strings.

30. The instrument of claim 29 wherein:
the set of permanent magnet(s) includes at least a first, second, third, fourth, fifth and sixth magnet; and
the first, second, third, fourth, fifth and sixth permanent magnets are respectively located in close proximity to the first, second, third, fourth, fifth and sixth pcb coil structures.

31. The instrument of claim 28 wherein:
the first pcb coil structure has an elongated footprint that is elongated in a direction of elongation of the first string; and
the second pcb coil structure has an elongated footprint that is elongated in a direction of elongation of the second string.
